(19) United States
(12) Patent Application Publication
(10) Pub. No.: US 2005/0268102 A1
(43) Pub. Date: Dec. 1, 2005

(54) Method and system for secure distribution of content over a communications network

(76) Inventor: Kyle F. Downey, Forest Hills, NY (US)

Correspondence Address: KENYON & KENYON, ONE BROADWAY, NEW YORK, NY, 10004, US

(21) Appl. No.: 11/123,758

(22) Filed: May 6, 2005

Related U.S. Application Data
(60) Provisional application No. 60/569,046, filed on May 7, 2004.

(51) Int. Cl. H04L 9/00

(52) U.S. Cl. 713/176

(57) ABSTRACT

A method and system for the secure distribution of content over a communications network such as the Internet where a content owner distributes content broken down into blocks to one or more content sources, the content sources serving as distribution points to subscribers, with the content owner retaining control over the distribution transaction. A subscriber requesting a content item from a content owner receives a list of content sources with available blocks of the content item in addition to the subscriber determining blocks available from peers on available peer-to-peer networks, and uses this information to determine a more optimal distribution of blocks of the content.

### FIELD OF THE INVENTION

The present invention relates to a method and system for the secure distribution of content over a communications network such as the Internet.

### BACKGROUND INFORMATION

The distribution of content over the Internet and other communications networks has involved overcoming several difficulties, most notably those involving the limitations of bandwidth. In particular, the distribution of larger-sized content such as, for example, video has faltered as existing hub-and-spoke video distribution schemes are fundamentally point-to-point between a subscription service and a subscriber allowing poorer economies of scale than broadcast or cable television. Existing commercial distribution schemes typically involve increasing bandwidth requirements and infrastructure costs with each additional customer.

Peer-to-peer (P2P) services attempt to solve the problem by distributing the bandwidth load across the P2P viewers' computers and Internet connections but create additional problems regarding legal and secure distribution. Content distributed over P2P services is generally unencrypted and often illegally obtained. P2P services may help solve technical constraints but raise the specter of piracy.

### SUMMARY

In accordance with an example embodiment of the present invention, content distribution is separated from access control. In one embodiment of the present invention, a content owner breaks a content item down into blocks of information including any administrative block data that is necessary and any metadata provided for the content. The content owner distributes these blocks to one or more content sources. These content sources serve as the distribution points for the content item when it is sent to a subscriber according to this embodiment of the present invention. When a subscriber requests a content item from the content owner, the content owner returns to the subscriber a list of the content sources having some or all of the blocks available. This list of content sources may be prioritized geographically according to one embodiment of the present invention. The content owner provided list of content sources may also include load information (e.g., traffic or usage information) for the content sources in another embodiment of the present invention. The load information may be included as part of the prioritized list or may be provided by other means in other embodiments if load information is provided at all. In addition, a subscriber may determine if any peers on a P2P network to which the subscriber belongs also has any of the blocks of the content item available. Using this information on content sources and available blocks, the subscriber determines which sources it wants to receive blocks from and sends the appropriate requests to the sources for the blocks. This determination may include calculations designed to avoid bandwidth constraints and potential bottlenecks in order to expedite the distribution of the content according to one embodiment of the present invention.

In another embodiment of the present invention, the subscriber activates a viewer process on the subscriber's hardware when the subscriber requests a content item from a content owner. The viewer process receives from the content owner a list of content source with available blocks of the content item. The viewer process also scans the subscriber's P2P networks for available peer sources with blocks of the content item. The viewer determines from whom to request blocks of the content item and executes these requests. The viewer decrypts any received encrypted blocks and reassembles the blocks into the desired content item. After receipt of the content item, the viewer may become a peer source for the content item to other peers on the subscriber's P2P networks in another embodiment of the present invention.

One embodiment of the present invention relates to a method for secure distribution of a content item over a communications network. In one example of this embodiment, the method may include the steps of: selecting, by a subscriber, the content item from a content owner over the communications network; receiving, from the content owner, a content source for the content item, the content source having available at least one block of the content item; requesting, by the subscriber, at least one block of the content item from the content source; and receiving the at least one block of the content item.

Another example embodiment of the present invention relates to a method for secure distribution of a content item over a communications network. According to this example embodiment, the method may include the steps of: selecting, by a subscriber, the content item from a content owner over the communications network; receiving, from the content owner, a content source for the content item, the content source having available at least one block of the content item; finding, by the subscriber, a second content source for the content item, the second content source having available the block of the content item; requesting, by the subscriber, the block of the content item from at least one of the content source and the second content source; and receiving the block of the content item.

Another example embodiment of the present invention relates to a method for secure distribution of a content item over a communications network. According to this example embodiment, the method may include the steps of: distributing, by a content owner, the content item to a content source; receiving, by the content owner, a request for the content item from a subscriber; and providing, by the content owner, the content source to the subscriber, the content source provided as a function of a geographic location of the subscriber.

Another example embodiment of the present invention relates to a method for secure distribution of a content item over a communications network. According to this example embodiment, the method may include the steps of: distributing, by a content owner, the content item to a content source; receiving, by the content owner, a request for the content item from a subscriber; providing, by the content owner, the content source to the subscriber, the content source provided as a function of a geographic location of the subscriber; and verifying, with the content source, an authorization for the subscriber to receive the content item.

Another example embodiment of the present invention relates to a method for secure distribution of a content item over a communications network. According to this example embodiment, the method may include the steps of: receiving, from a content owner, a block of the content item; receiving, from a subscriber, a request for the block of the content item; adding an additional data item to the block of the content item; and sending the block to the subscriber.

Another example embodiment of the present invention relates to a method for secure distribution of a content item over a communications network. According to this example embodiment, the method may include the steps of: receiving, from a content owner, a block of the content item; receiving, from a subscriber, a request for the block of the content item; verifying, with the content owner, an authorization for the subscriber to receive the content item; adding an additional data item to the block of the content item; and sending the block to the subscriber.

### BRIEF DESCRIPTION OF THE DRAWINGS

FIG. 1 is a diagram illustrating the breaking down of a content item into blocks according to one embodiment of the present invention.

FIG. 2a is a diagram illustrating the structure of a block according to one embodiment of the present invention.

FIG. 2b is a diagram illustrating a content item broken down into blocks along with metadata according to one embodiment of the present invention.

FIG. 3a is a diagram illustrating the content distribution process according to one embodiment of the present invention.

FIG. 3b is a diagram illustrating the content distribution process according to another embodiment of the present invention.

FIG. 4 is a diagram illustrating the content distribution process according to one embodiment of the present invention.

### DETAILED DESCRIPTION

According to one embodiment of the present invention, an owner distributes content over a communications network by breaking the content down into smaller blocks that are distributed by other sources to a subscriber, with the content owner retaining control of the distribution transaction. A content item may include any type of content such as, for example, movies, video, music files, speech recordings, electronic books (ebooks), etc. A content item may be stored in a single file though other embodiments of the present invention will also work with content items stored across multiple files. This embodiment of the present invention works with all sizes of content (i.e., content items) even though a content item that is larger in size typically requires greater resources to transmit and consumes larger amounts of network bandwidth during transmission and this model is particularly advantageous with larger-sized content items. According to this embodiment of the present invention, a content owner uses one or more content sources, other than the content owner itself, to distribute a content item to the subscriber. The content owner maintains control over the distribution process by processing a subscriber request for a content item and initiating the distribution process.

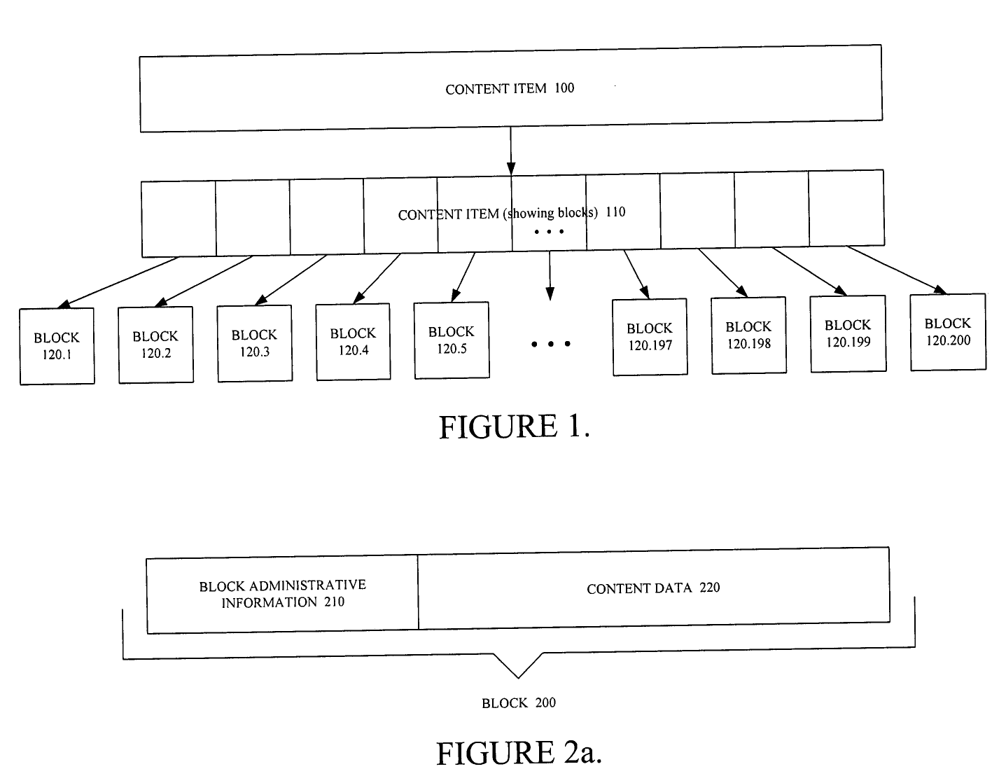

According to one embodiment of the present invention, a content item may be broken down into one or more blocks of data. For example, a content item representing a one-hour dramatic television episode may be contained in a single two-gigabyte file. In one example of this embodiment, the content item may be broken down into 10 megabyte blocks—200 blocks in total for this example. The 10 megabyte block size is only one example and other size blocks may be also be used. FIG. 1 is a diagram illustrating the breaking down of a content item into blocks according to one embodiment of the present invention. The content item 100 may be divided into discrete pieces of information 110 that are separated into separate blocks of data 120.1-120.200 according to one embodiment. In another embodiment of the present invention, the content item 100 may be arbitrarily broken down into specific-sized pieces of information 110 that are separated into separate blocks of data 120.1-120.200. There is no mandatory size to the blocks 120.1-120.200 and the blocks 120.1-120.200 may be the same size or may differ in size according to different embodiments of the present invention.

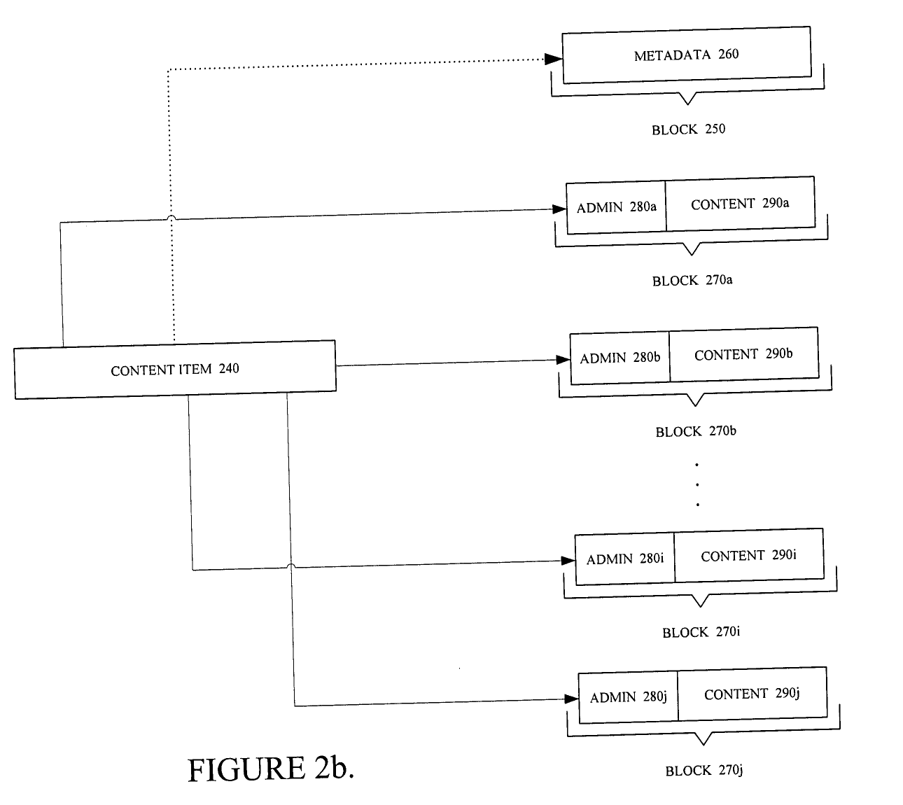

Each block of data 120.1-120.200 may contain administrative information in addition to the content data according to one embodiment of the present invention. For example, in addition to the content data, a block may also include an identifier to identify the content item. This identifier may be a universal unique identifier (UUID) associated with the original content item that uniquely identifies the content item to which the block belongs. A size of the block, an expiration data of the block, an MD5 (Message Digest Algorithm 5) checksum, and a sequence number are other examples of information that may be included in the administrative data of the block. For example, a sequence number may be used to indicate the position of this block in the content item and the order in which the blocks are to be reassembled. In another example, an MD5 checksum, a 128-bit (16-octet) checksum produced for the block content, or other value for verifying data integrity may be included in the administrative data of the block. FIG. 2a is a diagram illustrating the structure of a block according to one embodiment of the present invention. The block 200 is divided into two sections: a block administrative information section 210; and a content data section 220. The administrative data section 210 contains the additional non-content information in the block as discussed above and the content data section 220 contains a portion of the actual content item, for example, a portion of the one-hour dramatic television episode according to this embodiment.

A content item may also include a block of metadata according to one embodiment of the present invention. FIG. 2b is a diagram illustrating a content item broken down into blocks along with metadata according to one embodiment of the present invention. The metadata 260 may be derived from the information contained in the content item 240 or supplied as additional information from a content owner. In the example illustrated in FIG. 2b, the metadata 260 is contained in a separate block of data 250. In other embodiments of the present invention, the metadata may be contained in multiple blocks of data or mixed with content in one or more blocks. The block 250 of metadata 260 along with the other blocks 270a-270j containing block administrative data 280a-280j and the broken down content 290a-290j elements of the content item 240 comprise the content information to be distributed over the communications network according to the embodiment illustrated in FIG. 2b. The content blocks 270a-270j contain portions of the actual content item 240 while the metadata 260 may include, for example, a universal unique identifier (UUID) to identify the content item, a title for the content item, a description of the content item, the total number of blocks making up the content item, additional descriptive information regarding the content item (e.g., cast, director, etc.), and additional copyright information for the content item. Certain types of metadata 260 are used for identifying and reassembling the blocks of data 250, 270a-270j, for example, the UUID and total number of blocks. In various embodiments of the present invention, additional or alternative types of identification metadata may be used. Descriptive metadata may be used, for example, to provide additional information regarding the actual content 240 such as, for example, title, description, additional descriptive information, and additional copyright information. In various embodiments of the present invention, different types of descriptive metadata may be used. The metadata 260 may include information described in the video-on-demand specification for video distribution over cable.

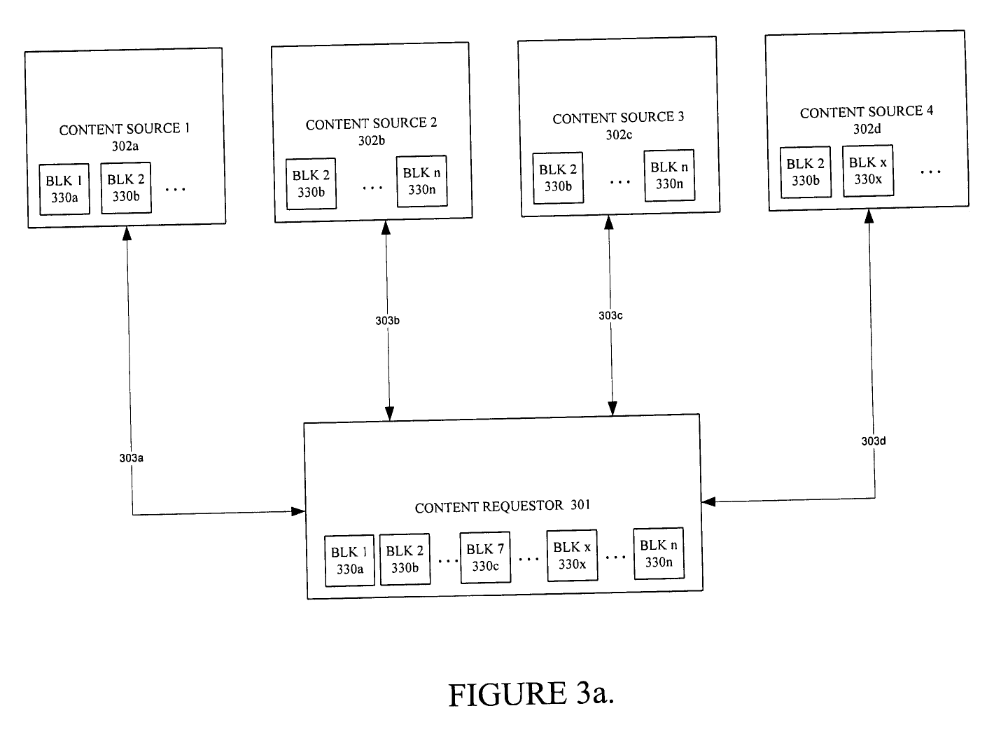

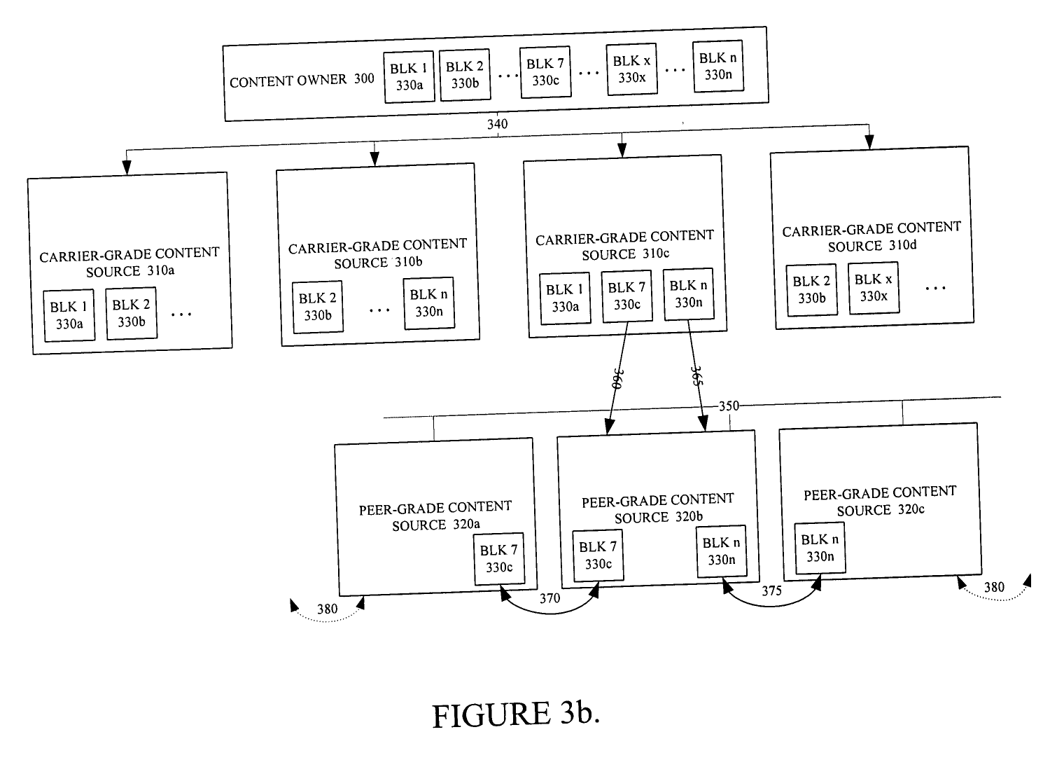

The blocks 250, 270a-270j are distributed by a content owner to a subscriber using various content sources. FIG. 3a is a diagram illustrating the content distribution process according to one embodiment of the present invention. A content requestor 301, also referred to as a subscriber, can be any user that connects with a content owner 305 over a communications network. The content requestor 301 requests a particular content item such as, for example, a movie or television episode, from the content owner 305. The content owner 305 sends 304 the content requestor 301 a list of content sources 302a-302d with the content available. The content requestor 301 requests 303a-303d blocks 330a-330n of content from the content sources 302a-302d based on the list of content sources received 304 from the content owner 305. The content requestor 301 receives 303a-303d the blocks 330a-330n and reassembles the content item. The content requestor 301 may query 303a-303d the content sources 302a-302d to determine which blocks 330a-330n they have available before requesting the blocks 330a-330n according to another embodiment of the present invention. FIG. 3b is a diagram illustrating the content distribution process according to another embodiment of the present invention. A content owner 300 is a copyright holder or authorized distributor for the content item 330 according to one embodiment of the present invention. According to the embodiment shown in FIG. 3, the content owner 300 divides the content 330 into blocks 330a-330n including any metadata blocks. Carrier-grade content sources 310a-310d, discussed in greater detail below, may include large information distributors over the communications networks and may have significant bandwidth capacity available. The content owner distributes 340 the blocks 330a-330n to carrier-grade content sources 310a-310d in a raw, unencrypted format according to this embodiment. In other embodiments, the blocks 330a-330n may be encrypted prior to transmission 340 to the carrier-grade content sources 310a-310d. The content owner 300 does not need to distribute 340 all the blocks 330a-330n for a content item 330 to each of the carrier-grade content sources 310a-310d though it may do so. Instead, a carrier-grade content source 310a-310d may receive none, some, or all of the blocks 330a-330n for a content item 330 according to one embodiment of the present invention. The distribution 340 of the blocks 330a-330n can occur using any method available to the communications network. For example, the blocks 330a-330n may be distributed 340 over the Internet using any available method such as transmission over wireless, satellite, or landline communications.

A content source 310a-310d, 320a-320c is any server on the communications network (e.g., the Internet) that can deliver blocks 330a-330n to a requester (i.e., a subscriber). A content source may include, for example, a peer computer on the communications network, a network service provider (e.g., Internet Service Provider—ISP), a content provider, a mobile telephone company (e.g., when using advanced 3G networks), etc. In one embodiment of the present invention, a content source 310a-310d, 320a-320c may have an agreement with the content owner 300 to receive and/or distribute some or all of the blocks 330a-330n representing a particular content item 330 or the content source 310a-310d, 320a-320c may receive some or all the blocks 330a-330n as part of the distribution process further discussed below. These agreements, when present, between a content owner and a content source may include a contract, a license agreement, or other such arrangement.

According to one embodiment of the present invention, a content source may be classified as either a carrier-grade content source 310a-310d or a peer-grade content source 320a-320c. A carrier-grade content source 310a-310d may be, for example, a very large distributor of information over the communications network and may have significant bandwidth capacity available, though other classes of carrier-grade content sources may exist. For example, a mobile telecommunications provider may be a carrier-grade content source for a movie studio content owner over a wireless telephone communications network. In this example, movie content owned by a studio content owner may be provided to a subscriber over the wireless telephone network by the mobile telephone company serving as the carrier-grade content source. A carrier-grade content source may have a formal distribution agreement with a content owner to distribute the content item to subscribers as previously mentioned. In one embodiment of the present invention, the content owner 300 transmits the entire content item 330 to a carrier-grade content source 310a-310d. The carrier-grade content source 310a-310d then breaks the content down into blocks of information and encrypts the content blocks before transmitting them to a subscriber.

In this embodiment, a peer-grade content source 320a-320c may be, for example, a computer of another subscriber who has previously requested the content item 330 with at least one block 330a-330n of the content item 330 still residing on the computer. A peer-grade content source 320a-320c may be connected to a subscriber (i.e., the content 330 requestor) through, for example, a peer-to-peer (P2P) network to which both the subscriber and the peer-grade content source belongs—often requiring the downloading of special software for the P2P network. Unlike a carrier-grade content source 310a-310d, the content owner 300 may not have a formal distribution agreement with the peer-grade content source 320a-320c but may rely on a license allowing the further distribution of the content blocks 330a-330n residing on the peer-grade content source according to one embodiment of the present invention. A peer-grade content source 320a-320c may exist on any P2P network to which the subscriber belongs including, for example, a proprietary P2P protocol network incorporating the features of the present invention. In another embodiment of the present invention, other P2P networks may be used such as Kazaa® and BitTorrent® where they further include expanded functionality for features such as, for example, digital rights management including digital watermarking, content access control, and encryption for the blocks. Belonging to a P2P network can consist of the subscriber either formally registering with the P2P network or merely having access to the P2P network through, for example, available software, being within a domain constraint, etc.

A peer-grade content source 320b may receive blocks 330c, 330n of content 330 distributed 360, 365 by a carrier-grade content source 310c when a subscriber at the peer-grade content source 320b downloads content 330 from the content owner 300 according to one embodiment of the present invention. Once the content item 330 has been viewed or otherwise consumed by a subscriber at a peer-grade content source 320b, some or all of the blocks may be deleted, overwritten or otherwise removed from the peer-grade content source 320b over time. In the example shown in FIG. 3, blocks 7 330c and n 330n of the content 330 still remain with the peer-grade content source 320b. These blocks are available to other peers 320a, 320c on the P2P network 350 if those other peers 320a, 320c download the same content item 330 from the content owner 300. In the example shown in FIG. 3, one peer-grade content source 320a receives block 7 330c distributed 370 by the first peer-grade content source 320b while a second peer-grade content source 320c receives block n 330n distributed 375 by the first peer-grade content source 320b. In turn, these additional peer-grade content sources 320a, 320c along with the first peer-grade content source 320b may further distribute 380 their available blocks 330c, 330n to other peers on the P2P network 350.

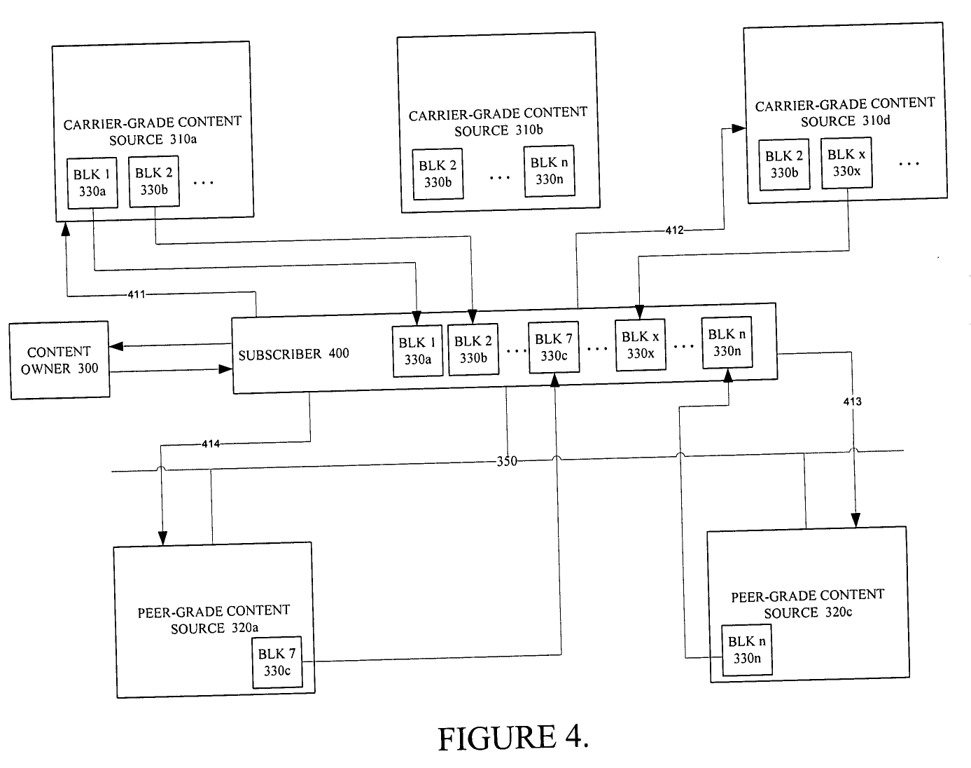

FIG. 4 is a diagram illustrating the content distribution process according to one embodiment of the present invention. A subscriber 400 represents one or more users having a subscription with one or more content owners 300 according to this embodiment of the present invention. A subscription may include an authentication arrangement to allow the content owner 300 to identify a subscriber 400 over the communications network. For example, an authentication arrangement may include a username and password. Other authentication arrangements may include a smart card. The authentication arrangement helps the content owner 300 identify and bill a subscriber 400 as necessary. In addition to an authentication arrangement, a subscription may include a PKI certificate with a public-private key pair for the subscriber 400 that is used to encrypt the blocks 330a-330n of content 330 sent to the subscriber 400. The public-private key pair may be created for the subscriber 400 by the content owner 300 in one embodiment of the present invention or may be selected/provided by the subscriber 400 to the content owner 300 in an another embodiment. In various embodiments, a subscription may include other information to facilitate the providing of content 330 to the subscriber 400 by the content owner 300. In another embodiment of the present invention, a dynamic transaction may be used instead of a subscription in order to provide content 330 from a content owner 300 to a subscriber (still referred to as a subscriber herein despite the lack of subscription). A dynamic transaction allows a subscriber (in this case a user) to access a content item without having an already established subscription.

The process illustrated in FIG. 4 begins with a subscriber 400 selecting a content item 330 from a content owner 300 (in FIG. 3) that the subscriber 400 wants to receive (e.g., download). According to this embodiment of the present invention, the selection of the content item 330 is made directly from the content owner 300. For example, a subscriber may select a content item, such as a one-hour dramatic television episode, from the content owner's web site on the Internet. In another example, a subscriber may select a content item, such as a music video, from a wireless access protocol (WAP)-enabled web site or phone menu of a content owner using a mobile phone or personal digital assistant (PDA). In one embodiment of the present invention, the selection of the content item 330 from the content owner 300 triggers an authentication process to verify the subscriber 400 using the subscriber information maintained by the content owner 300. If the subscriber 400 is new, a subscriber information account is first established with the content owner 300 before the selection of the content item 330 is processed according to this embodiment of the present invention. Depending on the authentication arrangement used, the authentication may or may not be transparent to the subscriber 400. For example, if a smart card is used for authentication, the authentication may occur in a transparent manner. However, in another example, if the subscriber 400 must provide a username and password or provide a fingerprint (i.e., an electronic fingerprint scan or other biometric data) to be used with the smart card, the process will not be transparent and will involve subscriber 400 interaction. In another embodiment of the present invention, the selection of the content item 330 by the subscriber 400 triggers a dynamic transaction requiring the subscriber 400 to supply necessary information to the content owner 300 in order to process the transaction.

The subscriber's 400 selection of the content item 330 from the content owner 300 may also trigger a viewer process for the subscriber 400 according to one embodiment of the present invention. In this embodiment, the viewer is a piece of software residing or running on the subscriber's hardware such as, for example, the subscriber's computer, television, mobile phone, media gateway, communications network-enabled device (e.g., Internet-enabled device), etc. In the case of a viewer connected to a wireless telephony network (e.g., the viewer running on an advance mobile phone device connected to a cellular network), exact information about the closest content source is immediately available if the network provider is a content source. If the viewer software is not available on the subscriber's hardware, the viewer software may first be transmitted/distributed/downloaded to the subscriber's hardware device. Subscriber 400 selection of the content item 330 triggers an instantiation of the viewer (i.e., the execution of a viewer process) according to this embodiment of the present invention. In one embodiment of the present invention, the viewer is involved in the authentication and/or dynamic transaction process. According to this embodiment, the viewer sends authentication information to the content owner 300 including, for example, a current IP address of the subscriber, username, password, a unique content identifier for the desired content item, etc. In an alternative embodiment, the viewer process is either triggered after the authentication or dynamic transaction process occurs or does not participate in the authentication or dynamic transaction process.

Following the authentication of the subscriber or the initiation of a dynamic transaction, the content owner 300 provides the viewer information about content sources according to one embodiment of the present invention. For example, content sources may be provided to the viewer by the content owner 300 ordered by proximity and load. In one embodiment of the present invention, the content owner 300 knows all the authorized carrier-grade content sources 310 for the content 330 and may use geolocation based on IP address or other similar services to map the viewer's current location (e.g., the viewer's current location may be determined through geolocation of an IP address provided to the content owner 300 by the viewer) to the location of the closest carrier-grade content sources. The degree of specificity in determining the proximity of carrier-grade content sources 310 to viewer and associated subscriber 400 depends on the detail available regarding the content source 310 and viewer/subscriber 400 locations. For example, if the content owner 300 can only determine that the viewer is located in France, it could provide any French carrier-grade content sources available followed by other Western European carrier-grade content sources. In another example, if the content owner 300 can determine that the viewer is located in New York City, the content owner could provide available carrier-grade content sources located in closest proximity to New York City. If the content owner 300 can't determine the location of a viewer, it may use a known home address for the subscriber 400 in one embodiment. Additionally, a content owner 300 may periodically communicate with authorized carrier-grade content sources 310 in order to determine load information concerning the carrier-grade content source according to one embodiment of the present invention. This information may be used to screen the carrier-grade content sources provided to a viewer according to one embodiment of the present invention. For example, if a carrier-grade content source 310b is a Japanese Internet service provider (ISP) that is heavily loaded because one or more routers are down, the content owner 300 may not include the Japanese ISP 310b as one of the carrier-grade content sources 310 provided to a viewer but may instead send, for example, other Japanese or possibly Korean carrier-grade content sources. This load information may also be sent to the viewer along with the carrier-grade content sources 310 with the viewer using the load information to determine which carrier-grade content sources 310 to use according to another embodiment of the present invention. In either embodiment, the content owner 300 refers the subscriber 400 to available carrier-grade content sources 310a, 310b, 310d that have some or all of the blocks 330a-330n of the content 330 available.

In addition, the subscriber 400 may also scan its local networks to determine if there are peer-grade carrier sources 320a, 320c available on any P2P networks 350 to which the subscriber 400 belongs and which the viewer can access according to one embodiment of the present invention. For example, the viewer may discover peer-grade carrier sources on its own using multicast (e.g., using zero configuration networking (Zeroconf) protocols). As part of the local (P2P) network scanning, the viewer determines which blocks 330a-330n a peer-grade carrier source 320a, 320c has available. The viewer also requests a list of blocks 330a-330n available from some or all of the carrier-grade content sources 310a, 310b, 310d provided by the content owner 300. Additionally, the viewer requests or receives information from the content owner 300 or carrier-grade content source 310 (i.e., a trusted source) regarding the list of blocks 330a-330n and possibly other information including, for example, the sizes of the blocks 330a-330n and their MD5 checksums (or other data verification values) for the content item 330 according to one embodiment of the present invention. Based on the information available, the viewer determines which content sources 310, 320 it will use to download the blocks 330a-330n constituting the content item 330. In one embodiment of the present invention, the viewer makes this determination in a manner designed to improve the distribution of the blocks 330a-330n over the communications network by avoiding busy content sources and scheduling the requests to avoid distribution bottlenecks. The viewer sends a request 411-414 for the blocks to the content source. For example, the viewer for a source 400 may send a request 411 for block 1 330a and block 2 330b of a content item 330 to a carrier-grade content source 310a. It may also send a request 412 for a block x 330x to a second carrier-grade content source 310d. Other blocks-block 7 330c and block n 330n—may be requested 414, 413 from peer-grade content sources—one request 414 a first peer-grade content source 320a and another request 413 to a second peer-grade content source 320c, respectively. If a public-private key is being used for encryption, the viewer also sends each content source 310, 320 its public key along with the request 411-414 for the blocks according to one embodiment of the present invention. According to this embodiment, the content source 310, 320 verifies with the content owner 300 that the public key or unique identifier of the subscriber 400 provided by the viewer is authorized to download the content item 330. The content source 310, 320 uses the subscriber's/viewer's public key to encrypt the requested blocks and then sends the blocks to the viewer.

As a result of the process described above, the blocks 330a-330n requested for the subscriber 400 by the viewer are distributed to the viewer over the communications network. In the example shown in FIG. 4, subscriber 400 receives blocks 1 330a and 2 330b distributed by a first carrier-grade content source 310a. Subscriber 400 does not request blocks from a second carrier-grade content source 310b. This may occur because of the load already on the second carrier-grade content source 310b or because of the location of the second carrier-grade content source 310b. Subscriber 400 receives block x 330x representing any of the other blocks of the content 330 distributed by a third carrier-grade content source 310d. Additionally, subscriber 400 receives block 7 330c and block n 330n, the final block of the content item 330, distributed respectively by a first peer-grade content source 320a and a second peer-grade content source 320c over a P2P network 350 on the communications network. The viewer decrypts as necessary any encrypted blocks 330a-330n received and assembles the received blocks 330a-330n to reconstitute the content item 330 for the subscriber 400. The viewer/subscriber hardware may now become a peer-grade content source 320 for the received blocks to other peer subscribers connected to the viewer over a P2P network.

According to one embodiment of the present invention, the content item 330 may include a digital watermark or audit trail information. For example, conventional digital watermark technology may be used to add information to each content item 330 according to this embodiment. This digital watermark information may include an audit trail of information indicating the sources through which the content item has passed. For example, if the content owner 300 is HBO who sends a content item 330 to a carrier-grade content source 310 Verizon®, whom in turn distributes the content item 330 to a subscriber John Smith with a unique identifier of “jsmith1” with John Smith serving as a peer-grade content source 320 distributing the content item 330 to another subscriber Larry David with identifier “ldavid79”, whom in turns further distributes the content item to Kyle Downey with identifier “kdowney1114”, the watermark may contain the following information:
source: HBO
share: jsmith1
share: ldavid79
share: kdowney1114.
   The same information may also be included in the metadata 260 of the content item 330 according one embodiment of the present invention instead of digitally watermarking the content item 330. The use of a watermark or metadata 260 for the entire content item 330 may not fully capture the audit trail for each block 330a-330n of content because a subscriber may receive content blocks from a number of sources. In another embodiment of the present invention, an audit trail or watermark may be kept according to blocks of information rather than the content item as a whole. As each content source prepares to distribute a block to a subscriber, the audit trail is further updated providing an accurate distribution trail of the content block. Incorporating an audit trail, whether through the use of a digital watermark or by other arrangement, helps the content owner determine where along the distribution path a content item or block of content was illegally obtained if unauthorized copies of the content item or block of content turn up elsewhere on the communications network. In addition to encrypting the blocks of data 330a-330n distributed to a subscriber, a digital watermark or metadata containing an audit trail helps to further ensure the security of the distribution process outlined in FIGS. 3 and 4.

1. A method for secure distribution of a content item over a communications network, comprising:
packaging the content item into a plurality of blocks of data;
distributing at least one block of data from the plurality of blocks of data for the content item to at least one of a content source and a peer-to-peer network, wherein the at least one content source and peer-to-peer network serve as a distribution point for the block of data;
receiving a request from a subscriber for the content item, the content item made available over the communications network; and
providing to the subscriber a list identifying at least one content source, wherein the listed content source makes available to the subscriber at least one block of data for the content item.

2. The method according to claim 1, further comprising:
verifying an authorization for the subscriber to access the content item; and
providing to the subscriber a list identifying at least one content source as a function of verifying the authorization, wherein the listed content source makes available to the subscriber at least one block of data for the content item.

3. The method according to claim 1, wherein the block of data represents a portion of the content item broken down to facilitate distribution of the content item over the communications network.

4. The method according to claim 1, wherein the at least one block of data for the content item includes at least one metadata block, wherein the metadata block contains metadata for the content item.

5. The method according to claim 1, wherein the subscriber is a viewer process running on behalf of a content subscriber.

6. The method according to claim 1, wherein the provided list identifying at least one content source is prioritized geographically.

7. The method according to claim 6, wherein the provided list identifying at least one content source is prioritized geographically as a function of a subscriber location.

8. The method according to claim 1, wherein the provided list additionally includes load information for the at least content source.

9. A method for secure distribution of a content item over a communications network, comprising:
receiving from a content owner a block of data for the content item;
receiving from a subscriber a request for the block of data for the content item, the request automatically generated without a user interaction as a function of a prior request to a content owner for the content item;
adding an additional data item to the block of data for the content item as a function of the received request; and
sending the block of data to the subscriber as a function of the received request.

10. The method according to claim 9, further comprising:
verifying with the content owner an authorization for the subscriber to receive the block of data as a function of the received request.

11. The method according to claim 9, wherein the block of data represents a portion of the content item broken down to facilitate distribution of the content item over the communications network.

12. The method according to claim 9, wherein the subscriber is a viewer process running on behalf of a content subscriber.

13. The method according to claim 9, wherein the additional data item is a digital watermark item.

14. The method according to claim 9, wherein the request includes at least one of a public key and a subscriber item.

15. The method according to claim 14, further comprising:
encrypting the block of data as a function of the request.

16. A method for secure distribution of a content item over a communications network, comprising:
receiving from a content owner the content item;
dividing the content item into a plurality of blocks of data in order to facilitate the distribution of the content item over the communications network;
receiving from a subscriber a request for a block of data for the content item, the request automatically generated without a user interaction as a function of a prior request to the content owner for the content item;
adding an additional data item to the block of data for the content item as a function of the received request; and
sending the block of data to the subscriber as a function of the received request.

17. The method according to claim 16, further comprising:
verifying with the content owner an authorization for the subscriber to receive the block of data as a function of the received request.

18. The method according to claim 16, wherein the subscriber is a viewer process running on behalf of a content subscriber.

19. The method according to claim 16, wherein the additional data item is a digital watermark item.

20. The method according to claim 16, wherein the request includes at least one of a public key and a subscriber item.

21. The method according to claim 20, further comprising:
encrypting the block of data as a function of the request.

22. A method for secure distribution of a content item over a communications network, comprising:
selecting the content item, the content item made available over the communications network by a content owner;
receiving from the content owner a list identifying a content source for the content item, the content source making available at least one block of data for the content item, the block of data representing a portion of the content item broken down to facilitate distribution of the content item over the communications network;
requesting at least one block of data from the content source automatically without a user interaction as a function of the selecting step; and
receiving the at least one block of data from the content source.

23. The method according to claim 22, further comprising:
receiving from the content owner a list identifying a content source for the content item, the list prioritized geographically and the content source making available at least one block of data for the content item, the block of data representing a portion of the content item broken down to facilitate distribution of the content item over the communications network.

24. The method according to claim 22, further comprising:
receiving from the content owner a list identifying a content source for the content item, the list prioritized geographically as a function of a subscriber location and the content source making available at least one block of data for the content item, the block of data representing a portion of the content item broken down to facilitate distribution of the content item over the communications network.

25. The method according to claim 24, further comprising:
requesting at least one block of data from the content source automatically without a user interaction as a function of the selecting step and as a function of the subscriber location.

26. The method according to claim 22, further comprising:
receiving from the content owner a list identifying a content source with associated load information for the content item, the content source making available at least one block of data for the content item, the block of data representing a portion of the content item broken down to facilitate distribution of the content item over the communications network.

27. The method according to claim 26, further comprising:
requesting at least one block of data from the content source automatically without a user interaction as a function of the selecting step and as a function of the load information.

28. A method for secure distribution of a content item over a communications network, comprising the steps of:
selecting the content item, the content item made available over the communications network by a content owner;
activating a viewer process as a function of selecting the content item;
receiving from the content owner a list identifying at least one content source for the content item, the content source making available at least one block of data for the content item, the block of data representing a portion of the content item broken down to facilitate distribution of the content item over the communications network;
searching by the viewer process for a peer-to-peer source for the content item, the peer-to-peer source making available at least one block of data for the content item;
requesting from a determined location the block of data for the content item, the determined location including at least one of the content source and the peer-to-peer source and the viewer process selecting the determined location automatically without a user interaction as a function of the selecting step and as a function of an availability for the block of data;
receiving by the viewer process the block of data from the determined location; and
assembling by the viewer process the block of data into the content item.

29. The method according to claim 28, wherein the received list identifying at least one content source is prioritized geographically.

30. The method according to claim 28, wherein the received list identifying at least one content source is prioritized geographically as a function of a subscriber location.

31. The method according to claim 30, further comprising:
requesting from a determined location the block of data for the content item, the determined location including at least one of the content source and the peer-to-peer source and the viewer process selecting the determined location automatically without a user interaction as a function of the selecting step and as a function of an availability for the block of data and as a function of the subscriber location.

32. The method according to claim 28, wherein the received list additionally includes load information for the at least content source.

33. The method according to claim 32, further comprising:
requesting from a determined location the block of data for the content item, the determined location including at least one of the content source and the peer-to-peer source and the viewer process selecting the determined location automatically without a user interaction as a function of the selecting step and as a function of an availability for the block of data and as a function of the load information.

34. The method according to claim 28, further comprising:
providing at least one of a public key and a subscriber item to the determined location for the block of data for the content item.

35. The method according to claim 28, further comprising:
serving as peer-to-peer source for the received block of data for the content item.

36. A system for secure distribution of a content item over a communications network, comprising:
a program memory;
a storage device; and
a processor, wherein the processor is adapted to:
(i) package the content item into a plurality of blocks of data;
(ii) distribute at least one block of data from the plurality of blocks of data for the content item to at least one of a content source and a peer-to-peer network, wherein the at least one content source and peer-to-peer network serve as a distribution point for the block of data;
(iii) receive a request from a subscriber for the content item, the content item made available over the communications network; and
(iv) provide to the subscriber a list identifying at least one content source, wherein the listed content source makes available to the subscriber at least one block of data for the content item.

37. A system for secure distribution of a content item over a communications network, comprising:
a program memory;
a storage device; and
a processor, wherein the processor is adapted to:
(i) receive from a content owner a block of data for the content item;
(ii) receive from a subscriber a request for the block of data for the content item, the request automatically generated without a user interaction as a function of a prior request to a content owner for the content item;
(iii) add an additional data item to the block of data for the content item as a function of the received request; and
(iv) send the block of data to the subscriber as a function of the received request.

38. A system for secure distribution of a content item over a communications network, comprising:
a program memory;
a storage device; and
a processor, wherein the processor is adapted to:
(i) receive from a content owner the content item;
(ii) divide the content item into a plurality of blocks of data in order to facilitate the distribution of the content item over the communications network;
(iii) receive from a subscriber a request for a block of data for the content item, the request automatically generated without a user interaction as a function of a prior request to the content owner for the content item;
(iv) add an additional data item to the block of data for the content item as a function of the received request; and
(v) send the block of data to the subscriber as a function of the received request.

39. A system for secure distribution of a content item over a communications network, comprising:
a program memory;
a storage device; and
a processor, wherein the processor is adapted to:
(i) select the content item, the content item made available over the communications network by a content owner;
(ii) receive from the content owner a list identifying a content source for the content item, the content source making available at least one block of data for the content item, the block of data representing a portion of the content item broken down to facilitate distribution of the content item over the communications network;
(iii) request at least one block of data from the content source automatically without a user interaction as a function of the selecting step; and
(iv) receive the at least one block of data from the content source.

40. A system for secure distribution of a content item over a communications network, comprising:
a program memory;
a storage device; and
a processor, wherein the processor is adapted to:
(i) select the content item, the content item made available over the communications network by a content owner;
(ii) activate a viewer process as a function of selecting the content item;
(iii) receive from the content owner a list identifying at least one content source for the content item, the content source making available at least one block of data for the content item, the block of data representing a portion of the content item broken down to facilitate distribution of the content item over the communications network;
(iv) search by the viewer process for a peer-to-peer source for the content item, the peer-to-peer source making available at least one block of data for the content item;
(v) request from a determined location the block of data for the content item, the determined location including at least one of the content source and the peer-to-peer source and the viewer process selecting the determined location automatically without a user interaction as a function of the selecting step and as a function of an availability for the block of data;
(vi) receive by the viewer process the block of data from the determined location; and
(vii) assemble by the viewer process the block of data into the content item.

41. A computer readable medium including instructions adapted to execute a method for secure distribution of a content item over a communications network, the method comprising:
packaging the content item into a plurality of blocks of data;
distributing at least one block of data from the plurality of blocks of data for the content item to at least one of a content source and a peer-to-peer network, wherein the at least one content source and peer-to-peer network serve as a distribution point for the block of data;
receiving a request from a subscriber for the content item, the content item made available over the communications network; and
providing to the subscriber a list identifying at least one content source, wherein the listed content source makes available to the subscriber at least one block of data for the content item.

42. A computer readable medium including instructions adapted to execute a method for secure distribution of a content item over a communications network, the method comprising:
receiving from a content owner a block of data for the content item;
receiving from a subscriber a request for the block of data for the content item, the request automatically generated without a user interaction as a function of a prior request to a content owner for the content item;
adding an additional data item to the block of data for the content item as a function of the received request; and
sending the block of data to the subscriber as a function of the received request.

43. A computer readable medium including instructions adapted to execute a method for secure distribution of a content item over a communications network, the method comprising:
receiving from a content owner the content item;
dividing the content item into a plurality of blocks of data in order to facilitate the distribution of the content item over the communications network;
receiving from a subscriber a request for a block of data for the content item, the request automatically generated without a user interaction as a function of a prior request to the content owner for the content item;
adding an additional data item to the block of data for the content item as a function of the received request; and
sending the block of data to the subscriber as a function of the received request.

44. A computer readable medium including instructions adapted to execute a method for secure distribution of a content item over a communications network, the method comprising:
selecting the content item, the content item made available over the communications network by a content owner;
receiving from the content owner a list identifying a content source for the content item, the content source making available at least one block of data for the content item, the block of data representing a portion of the content item broken down to facilitate distribution of the content item over the communications network;
requesting at least one block of data from the content source automatically without a user interaction as a function of the selecting step; and
receiving the at least one block of data from the content source.

45. A computer readable medium including instructions adapted to execute a method for secure distribution of a content item over a communications network, the method comprising:
selecting the content item, the content item made available over the communications network by a content owner;
activating a viewer process as a function of selecting the content item;
receiving from the content owner a list identifying at least one content source for the content item, the content source making available at least one block of data for the content item, the block of data representing a portion of the content item broken down to facilitate distribution of the content item over the communications network;
searching by the viewer process for a peer-to-peer source for the content item, the peer-to-peer source making available at least one block of data for the content item;
requesting from a determined location the block of data for the content item, the determined location including at least one of the content source and the peer-to-peer source and the viewer process selecting the determined location automatically without a user interaction as a function of the selecting step and as a function of an availability for the block of data;
receiving by the viewer process the block of data from the determined location; and
assembling by the viewer process the block of data into the content item.
